(19) United States
(12) Patent Application Publication
(10) Pub. No.: US 2026/0208772 A1
(43) Pub. Date: Jul. 23, 2026

(54) AN AUTOMATED STORAGE AND RETRIEVAL SYSTEM COMPRISING A SERVICE VEHICLE AND A SERVICE SLED

(71) Applicant: AutoStore Technology AS, Nedre Vats (NO)

(72) Inventors: Trond Austrheim, Etne (NO); Ivar Fjeldheim, Haugesund (NO)

(21) Appl. No.: 19/140,254

(22) PCT Filed: Nov. 27, 2023
(86) PCT No.: PCT/EP2023/083218

§ 371 Date: Jun. 17, 2025

(30) Foreign Application Priority Data
Dec. 20, 2022 (NO) 20221374

(51) Int. Cl. B61D 15/00; B61B 5/02; B61C 13/04; B61F 5/50; B65G 1/04

(52) U.S. Cl. CPC B61D 15/00; B61B 5/02; B61C 13/04; B61F 5/50; B65G 1/0464

(57) ABSTRACT

The present invention provides a storage system comprising a framework structure (100) having a plurality of storage columns (105) accommodating a vertical stack of storage containers (106), and a rail system (108) upon which vehicles (2, 201,301,401) may move in two perpendicular directions above the storage columns; the rail system comprises a first set of parallel rails (110) arranged to guide movement of the vehicles in a first direction (X) across the top of a frame structure, and a second set of parallel rails (111) arranged perpendicular to the first set of rails to guide movement of the vehicles in a second direction (Y) which is perpendicular to the first direction (X), the first and second sets of parallel rails defining a plurality of grid cells (122); wherein the storage system comprises a service vehicle (2) and at least one service sled (3), the service vehicle (2) is configured to accommodate a human operator and comprises wheels (4a,4b), for moving the service vehicle in the first direction and the second direction upon the rail system, and at least one sled connector (5) to releasably attach the service vehicle (2) to the service sled (3), and the service sled (3) is configured to slide upon the rail system.

### FIELD OF THE INVENTION

The present invention relates to an automated storage and retrieval system comprising a service vehicle and a service sled.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a horizontal grid-based rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The rail system 108 defines a plurality of grid cells 122. A lateral area of a grid cell 122 includes the area of the access opening 112 and half the width of the rails at the periphery of the access opening. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 404d comprising container connectors 404b and guiding pins 404c adapted to engage a storage container 106. The lifting frame 404d can be lowered from the vehicle 201,301,401 so that the position of the lifting frame 404d with respect to the vehicle 201,301,401 can be adjusted in a third direction Z which is orthogonal the first direction Y and the second direction X. The lifting device of the container handling vehicle 201 is located within the vehicle body 201a in FIG. 2.

To raise or lower the lifting frame 404d (and optionally a connected storage container 106), the lifting frame 404d is suspended from a band drive assembly by lifting bands 404a. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The lateral area defined by a storage column is equal to the lateral area defined by a grid cell 122 of the rail system 108. The lateral area of a grid cell includes the area of the access opening 112 and half the width of the rails at the periphery of the access opening.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lift device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

There are several known solutions to service vehicles operating on the grid of a storage and retrieval system. Service vehicles may be used for various operations such as retrieving a malfunctioning container handling vehicle or allowing access for an operator to repair faulty equipment arranged on the grid.

The aim of the present invention is to provide a simple and efficient system for performing operations upon a rail grid of a prior art storage and retrieval system as described above.

### SUMMARY OF THE INVENTION

The present invention is defined in the attached claims and in the following:

In a first aspect, the present invention provides a storage system comprising a framework structure having a plurality of storage columns accommodating a vertical stack of storage containers, and a rail system upon which vehicles may move in two perpendicular directions above the storage columns; the rail system comprises a first set of parallel rails arranged to guide movement of the vehicles in a first direction across the top of a frame structure, and a second set of parallel rails arranged perpendicular to the first set of rails to guide movement of the vehicles in a second direction which is perpendicular to the first direction, the first and second sets of parallel rails defining a plurality of grid cells;
wherein
the storage system comprises a service vehicle and at least one service sled,
the service vehicle is configured to accommodate a human operator and comprises wheels, for moving the service vehicle in the first direction and the second direction upon the rail system, and at least one sled connector to releasably attach the service vehicle to the service sled, and
the service sled is configured to slide upon the rail system.

The at least one sled connector is configured such that the service sled mimics or follows the horizontal movement of the service vehicle when the service sled and the service vehicle are attached.

In other words, the service sled is configured to slide upon the rail system when attached to the service vehicle and the service vehicle moves in any of the first direction and the second direction.

In an embodiment of the storage system, the service sled may comprise a floor section having a bottom surface in sliding contact with rails of the rail system. The floor section, i.e. the bottom surface of the floor section, may be in sliding contact with an upper surface or portion of the rail system. In other words, the bottom surface may be in contact with and supported by rails of the rail system, such that the service sled may slide upon the rail system.

In an embodiment of the storage system, the bottom surface may be flat.

In an embodiment of the storage system, the bottom surface may have an area larger than a lateral area of two adjacent grid cells. In other words, the bottom surface may be larger, or cover more, than a lateral area of two adjacent grid cells. The lateral area of a grid cell includes the area of the access opening of a storage column and half the width of the rails at the periphery of the access opening.

In an embodiment of the storage system, the bottom surface may be made of a material having a lower hardness than the material of the rail system. In other words, the bottom surface is made of a material suitable to avoid wear/scratching/denting of the rails.

In an embodiment of the storage system, the bottom surface may be made of a polymeric material. Suitable polymeric materials include HDPE, LDPE, PET, PP and PA. The polymeric material may have a hardness being lower than the hardness of the rail system, i.e. a hardness being lower than aluminium.

In an embodiment of the storage system, the floor section may comprise a rounded edge, or upwards inclined edge surface, at the periphery of the bottom surface.

In an embodiment of the storage system, the rail system may be made of aluminium.

In an embodiment of the storage system, the service sled may be any of a platform for a human operator, a cleaning tool comprising a brush and/or a vacuum cleaner, and a tool sled featuring a manual lifting device for retrieval of a storage container.

In an embodiment of the storage system, the service sled may comprise a railing. A portion of the railing may be moveable between opposite sides of the service sled, such that an operator may exit the service vehicle and enter the service sled from any of the opposite sides.

In an embodiment, the storage system may comprise two service sleds, the service sleds configured to be releasably attached at opposite sides of the service vehicle to provide a platform for a human operator, the platform extending around a periphery of the service vehicle.

In an embodiment of the storage system, the at least one sled connector may be configured to restrict horizontal movement of the service sled relative to the service vehicle when the service vehicle is attached to the service sled.

In an embodiment of the storage system, the at least one sled connector may be configured to allow vertical movement of the service vehicle relative to the service sled when the service vehicle is attached to the service sled. In other words, the sled connector may be configured such that the service sled is not lifted/lowered when the service vehicle changes direction of travel.

In an embodiment of the storage system, the service sled may comprise at least one bracket for releasable attachment to the sled connector. One side of the service sled may comprise two brackets for releasable attachment to two corresponding sled connectors of the service vehicle. The two brackets may be arranged at opposite edges of the one side of the service vehicle. By use of two brackets and two corresponding sled connectors, twisting of the service sled in the horizontal plane is prevented.

In an embodiment of the storage system, the service sled may comprise two brackets on each of two opposite sides, such that a service vehicle may releasably attach to the service sled from any of the two opposite sides.

In an embodiment of the storage system, the at least one sled connector is configured to releasably attach the service sled via a pin-hole connection. The pin may be arranged in a vertical direction providing a pin-hole connection allowing vertical movement of the service sled relative to the service vehicle while restricting horizontal movement therebetween.

In an embodiment of the storage system, the at least one sled connector may comprise a vertically moveable pin and the service sled comprises a corresponding hole into which the pin may be inserted to releasably attach the service sled. The pin may be moved in a vertical direction between a first position in which the hole may be arranged below or above the rod, and a second position in which the rod may be inserted into the hole. The hole may be part of a bracket connected to the service sled. The pin may be configured to be inserted into the hole to prevent or restrict horizontal movement of the service sled relative to the service vehicle when the service vehicle is attached to the service sled. The sled connector may comprise a gripping section attached to, or forming an integral part of, one end of the pin, wherein the gripping section allows a human operator to grip and lift the pin using their hand.

In an embodiment of the storage system, the service vehicle may comprise two sled connectors on at least one side thereof, wherein the two sled connectors are arranged with an offset along the first direction or the second direction. The service vehicle may comprise two connectors on each of two opposite sides thereof, wherein the two connectors on each opposite side are arranged with an offset along the first direction or the second direction. The offset being sufficient to prevent twisting of the service sled in the horizontal plane.

In an embodiment of the storage system, the service vehicle may comprise a first set of wheels and a second set of wheels, wherein at least one of the sets of wheels can be lifted and lowered, so that the first set of wheels and the second set of wheels can be engaged with a respective set of rails at any one time.

In an embodiment, the storage system may comprise at least one container handling vehicle configured to move in two perpendicular directions above the storage columns, the container handling vehicle being able to retrieve storage containers from, and store storage containers in, the storage columns, and transport the storage containers on the rail system.

In an embodiment of the storage system, the service vehicle may comprise a railing having a gate, the gate allowing access for a human operator to a service sled attached to the service vehicle.

In a second aspect, the present invention provides a method of moving a service sled in a storage system according to any embodiment of the first aspect, comprising the steps of:
moving the service vehicle to a first position being adjacent to the service sled;
releasably attaching the service vehicle to the service sled by use of the at least one sled connector; and
sliding the service sled upon the rail system by moving the service vehicle to a second position.

The term “storage system” is intended to encompass systems comprising any type of containers, bins or frames that may accommodate any type of item, goods or merchandise, including growth media in which plants may be cultivated. In the latter case, the container handling system may be used for vertical farming.

In an embodiment, the storage system may comprise vertical column profiles supporting the rail system from below, the column profiles defining multiple storage columns in which containers may be stacked on top of each other.

In an embodiment of the storage system, each storage column is defined by four of the vertical column profiles.

### BRIEF DESCRIPTION OF THE DRAWINGS

Embodiments of the present invention are described in detail by way of example only and with reference to the following drawings:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIGS. 5-7 are perspective views of a service vehicle for use in a storage system according to the invention.

FIGS. 8-11 are perspective views of a first exemplary storage system according to the invention.

FIGS. 12A and 12B are perspective views of a second exemplary storage system according to the invention.

FIG. 13 is a perspective view of various service sleds for use in a storage system according to the invention.

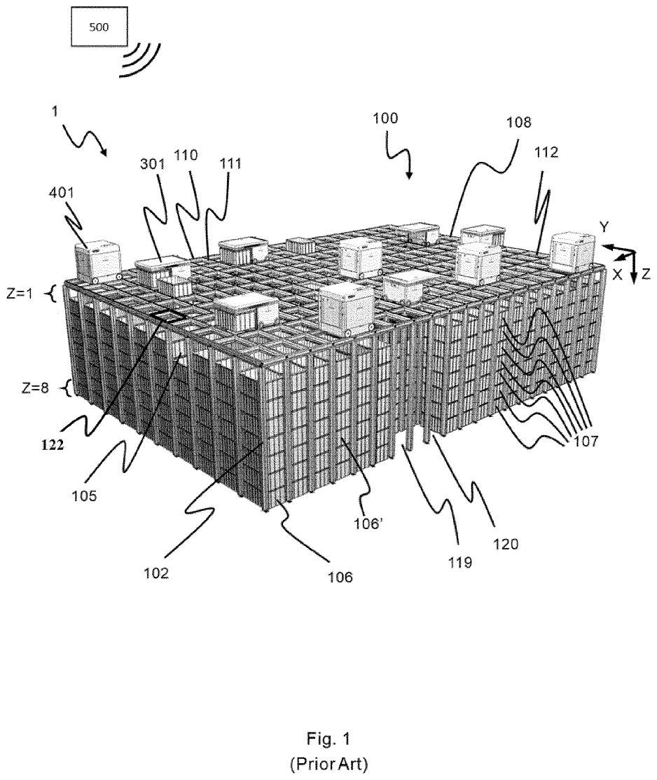

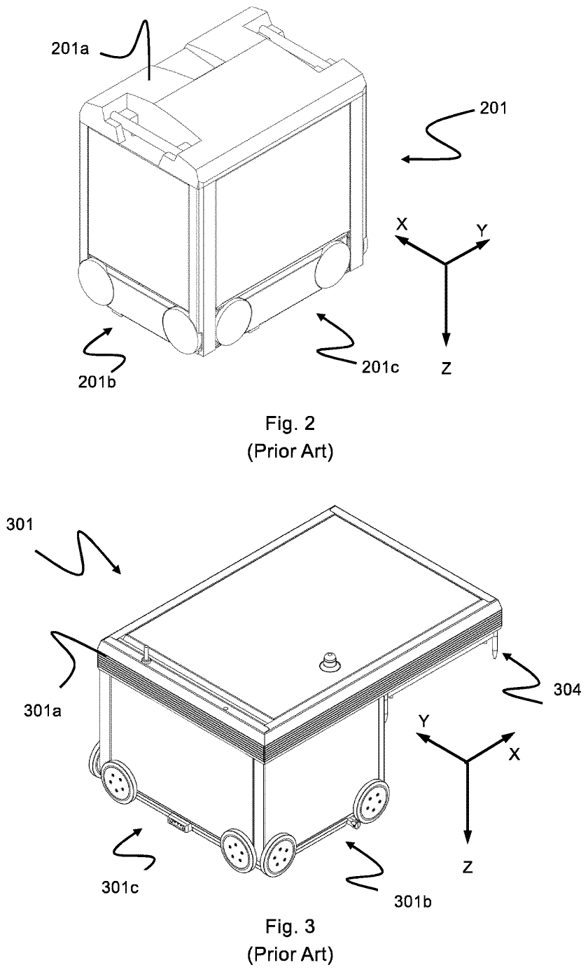

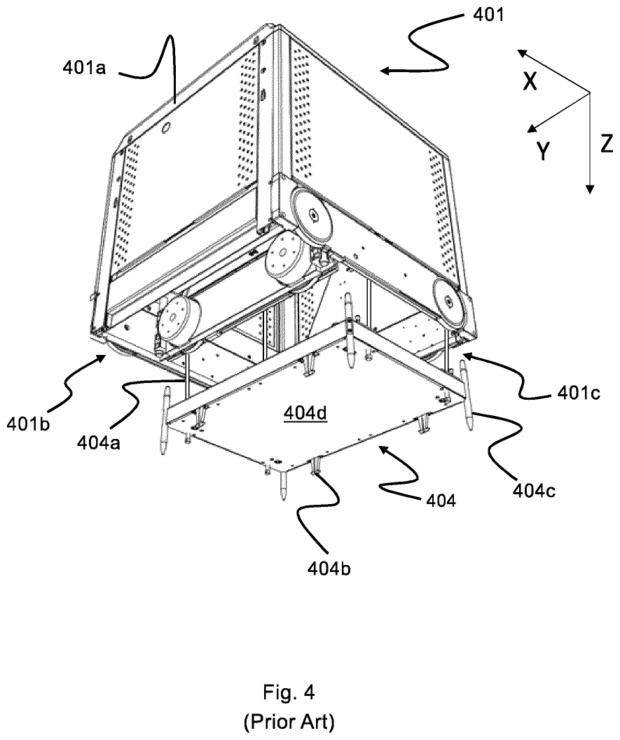

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

As mentioned above, service vehicles may be used to transfer a human operator on a rail system 108 of a storage system 1 to e.g. allow access for repairing or retrieving malfunctioning equipment, such as a container handling vehicle 201,301,401. However, the service vehicles are commonly quite small, having only room for a single human operator, and does not provide a sufficient or optimal workspace upon the rail system. Other operations that may also be required upon the rail system include cleaning of the rail system and retrieval of storage containers that are stuck within the storage columns. Larger specialized service vehicles for providing a larger workspace, cleaning the rail system etc. may be envisioned, but would be costly and require an extended wheel assembly for sufficient support and correct movement of the service vehicle upon the rail system.

The present invention provides a storage system in which multiple operations may be performed upon the rail system in a cost efficient and simple manner.

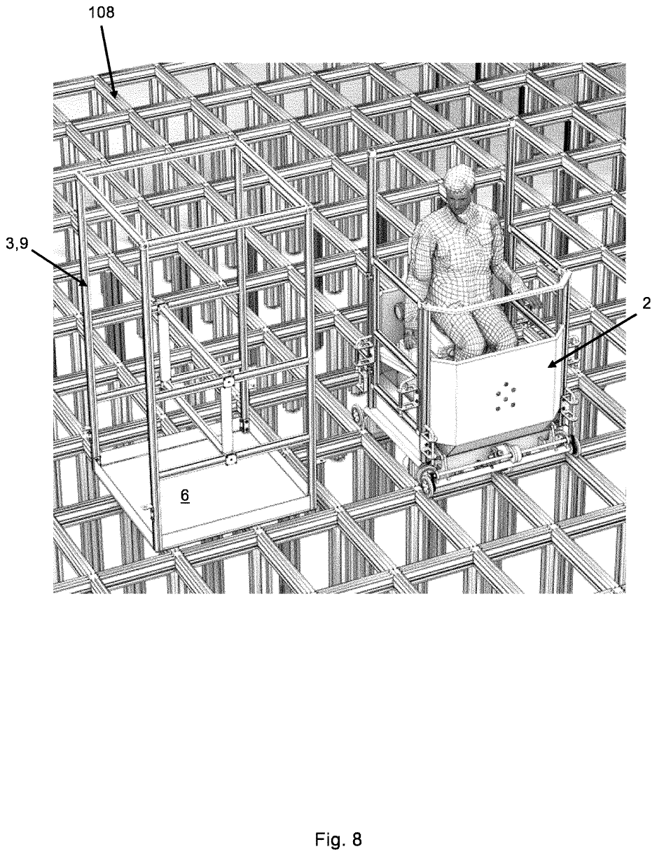

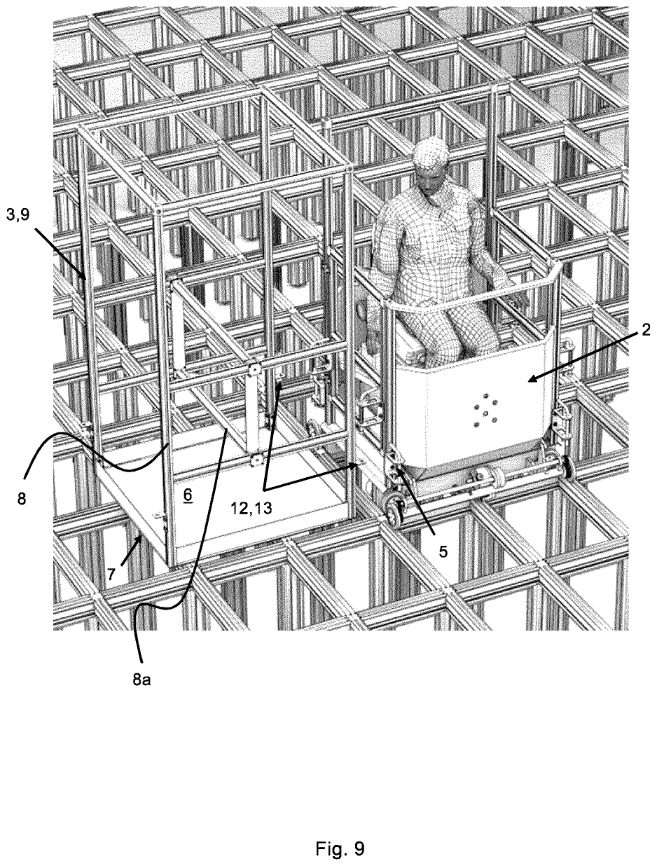

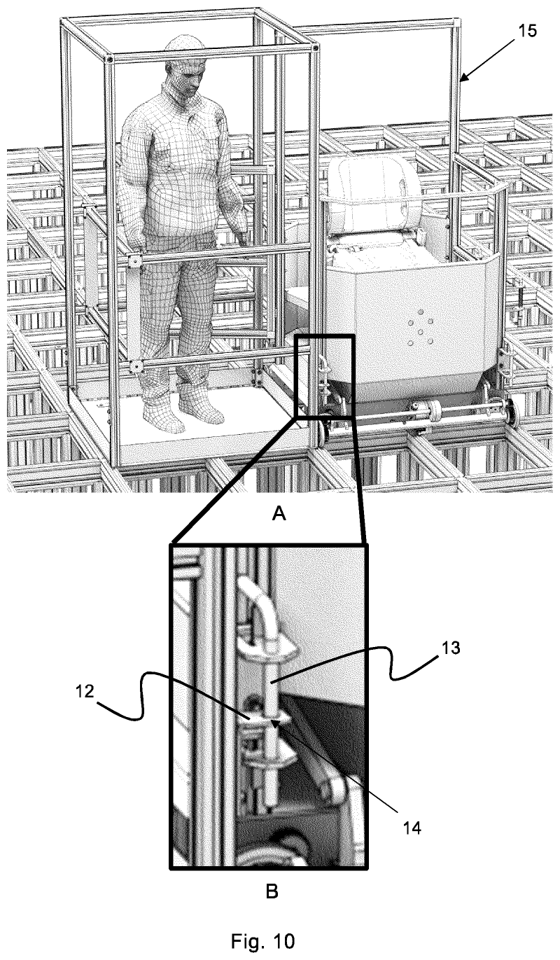

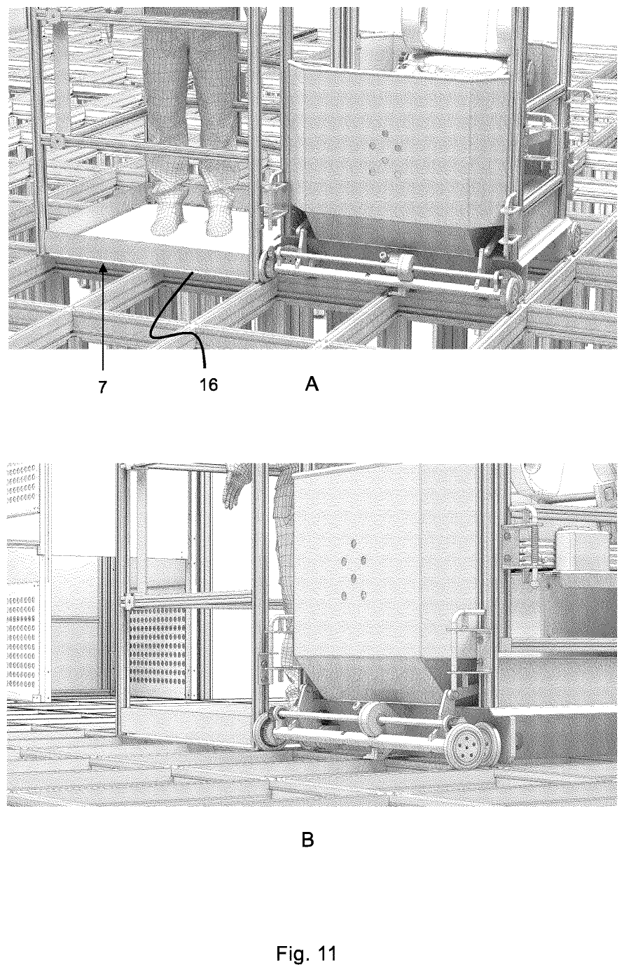

The inventive storage system features a service vehicle 2 and at least one service sled 3, see FIGS. 7-10 and 11.

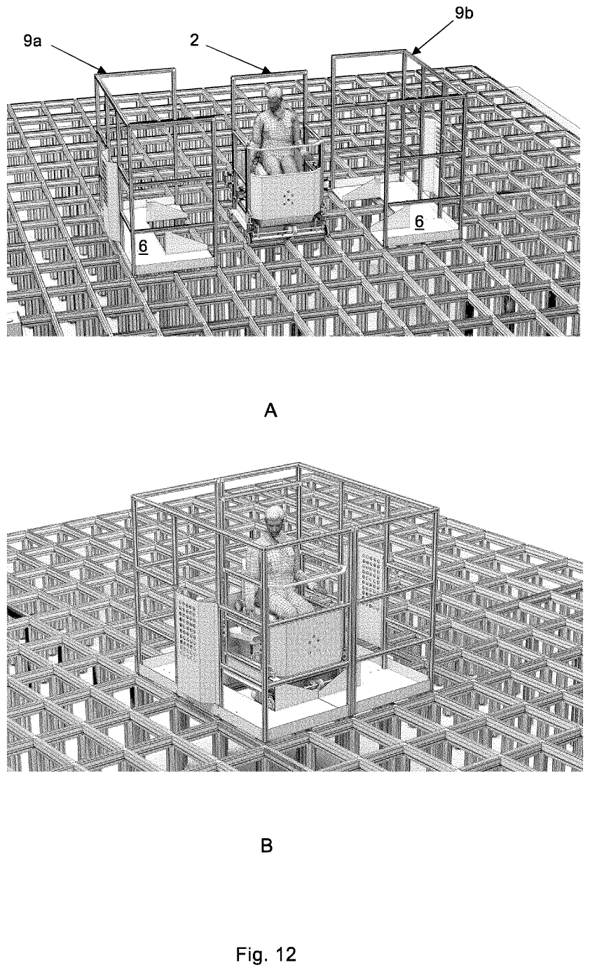

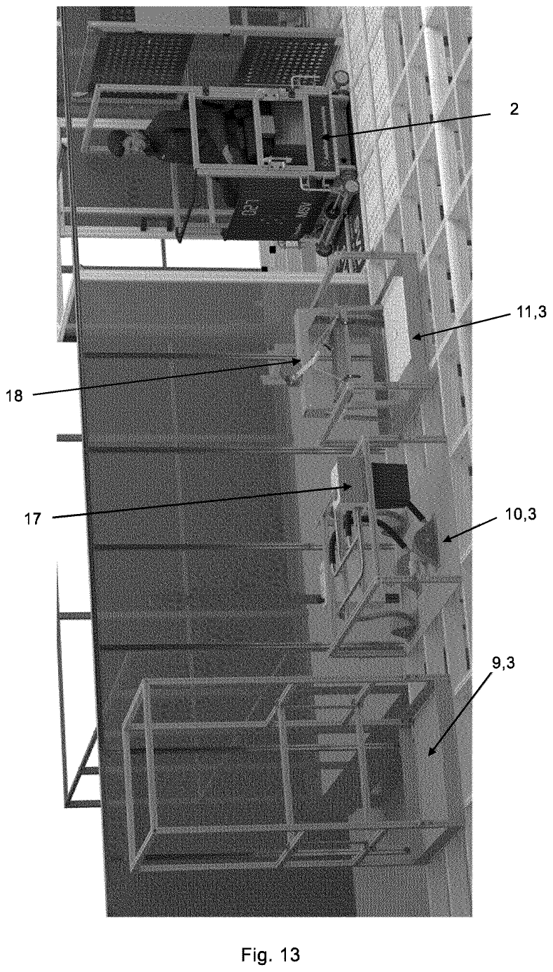

The service sled 3 may be configured for a wide variety of services or uses, see FIG. 12, such as providing a platform 9 with workspace for a human operator, a cleaning tool 10 having a brush and/or a vacuum cleaner 17 for removing debris/spillage upon the rail system 108, or a tool sled 11 featuring a manual lifting device 18 for retrieval of storage containers that are not retrievable by a container handling vehicle.

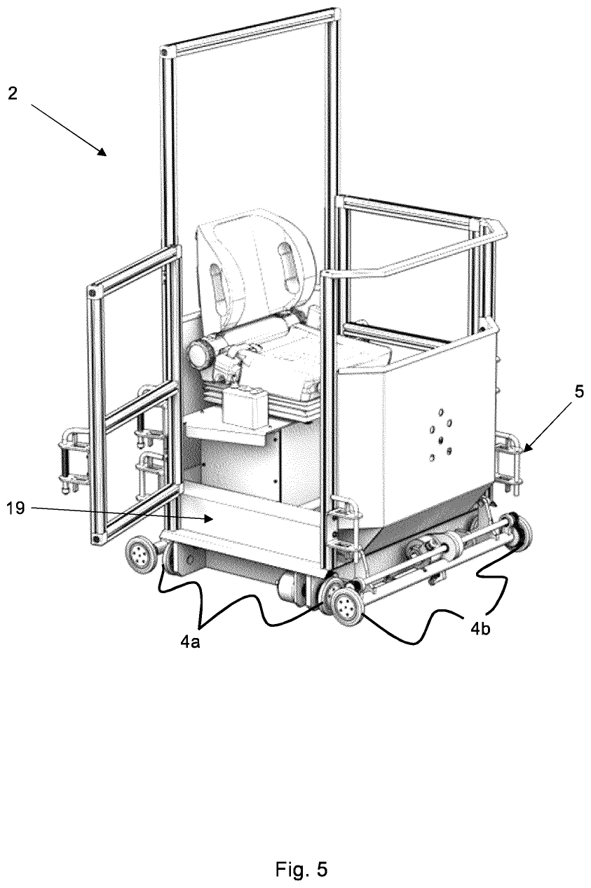

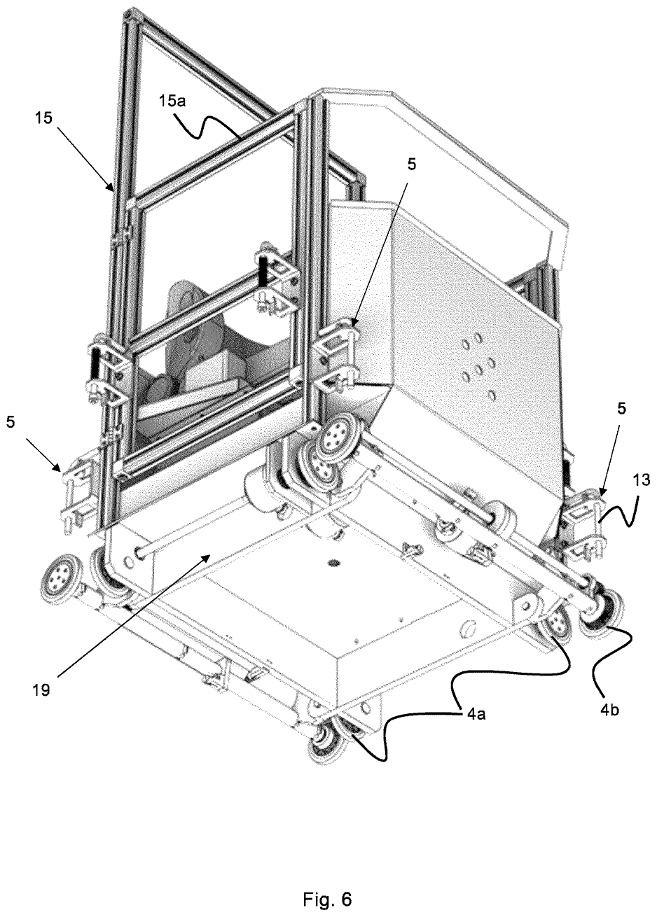

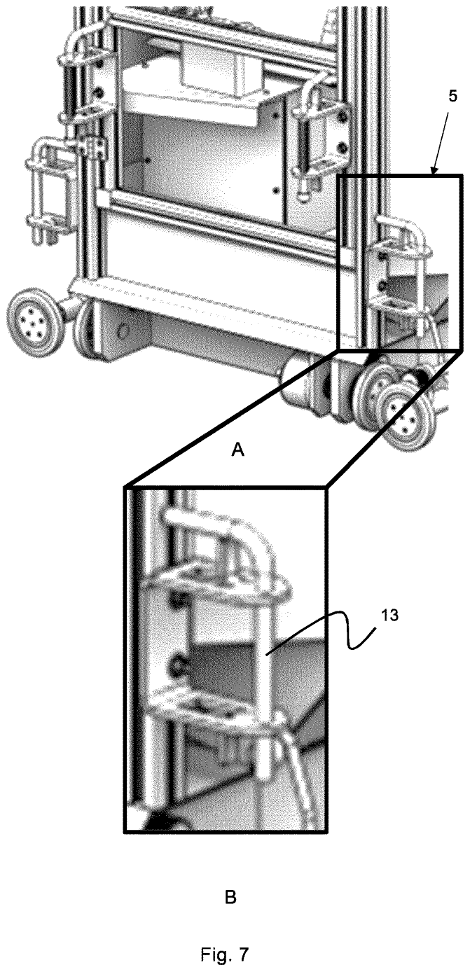

An exemplary service vehicle 2 is disclosed in FIGS. 5-7. The service vehicle 2 is configured to accommodate a human operator and features a wheel assembly having a first set of wheels 4a and a second set of wheels 4b for moving the service vehicle in two perpendicular directions upon the rail system 108. One of the sets of wheels can be lifted and lowered, so that the first set of wheels 4a and the second set of wheels 4b can be engaged with a respective set of rails 110,111 at any one time. In the disclosed service vehicle, only the second set of wheels is 4b vertically movable relative to a vehicle body 19 of the service vehicle. Thus, when the service vehicle travels on the second set of wheels the vehicle body 19 is at a higher level relative to the rail system than when travelling on the first set of wheels 4a.

The service vehicle 2 features four separate sled connectors 5 to releasably attach the service vehicle 2 to the service sled 3, see FIGS. 7-9. A pair of sled connectors 5 are arranged on each of two separate sides of the service vehicle, such that the service vehicle 2 may attach the service sled 3 on any of the two opposite sides. The sled connectors 5 are configured such that the service sled 3 will mimic the horizontal movement of the service vehicle when the service sled 3 and the service vehicle 2 are attached. In the illustrated embodiment, each of the sled connectors 5 is configured to releasably attach the service sled 3 via a pin-hole connection. The pin-hole connection is obtained by a vertically moveable pin 13 of the sled connector 5 and a corresponding hole 14 in a bracket 12 of the service sled 3. The pin-hole connection is configured to allow vertical movement between the service vehicle 2 and the attached service sled 3. The relative vertical movement allowed by the pin-hole connection is required when the level of an attached service sled 3 should be kept constant during movement of the service vehicle 2 in any direction. In other embodiments, the service vehicle and the service sled may be releasably attached by any suitable connection providing the relative vertical movement while restricting horizontal movement between the service sled 3 and the service vehicle 2. In other embodiments, the service vehicle 2 may have a wheel assembly wherein the vehicle body is at the same level independent of the direction of travel, and the relative vertical movement provided by the pin-hole connection may not be required.

When attached to the service vehicle 2, the service sled 3 is configured to slide upon the rail system when the service vehicle moves 2. The service sled 3 comprises a floor section 6 having a flat bottom surface 7 in sliding contact with the rails 110,111 of the rail system 108. The bottom surface 7 has an area larger than a lateral area of two adjacent grid cells 122 to ensure sufficient support of the service sled by the rail system. Having the service sled 3 configured to slide upon the rails 110,111, instead of using a wheel assembly similar to the service vehicle, provides a very simple, durable and cost efficient solution for transport upon the rail system 108. The rails are commonly made of aluminium and to minimize wear it is preferable that the bottom surface 7 is made of a material having a lower hardness than the aluminium alloy of the rails. The bottom surface may preferably be made off a polymeric material, such as a suitable grade of HDPE, LDPE, PET, PP or PA. To further minimize wear of the rails, the floor section 6 may comprise a rounded edge 16, or upwards inclined edge surface, at the periphery of the bottom surface 7.

The service vehicle 2 comprises a railing 15 having a gate 15a on at least one side thereof. The gate 15a allows access for a human operator to an attached service sled 3.

When used as a platform 9 for a human operator, the service sled 3 may also comprise a railing 8. To allow an operator to exit the service vehicle 2 and enter the platform 9 from any of two opposite sides a portion 8a of the railing 8 may be moved between opposite sides of the service sled 3.

In an exemplary embodiment, the inventive storage system may comprise two separate service sleds 3 configured to be releasably attached at opposite sides of the service vehicle 2. The service sleds provide a common platform 9a,9b for a human operator extending around a periphery of the service vehicle 2.

### LIST OF REFERENCE NUMBERS

1 Prior art automated storage and retrieval system
2 Service vehicle
3 Service sled
4a,4b Wheels, first set of wheels, second set of wheels
5 Sled connector
6 Floor section
7 Bottom surface
8 Railing
8a Moveable railing portion
9 Platform
10 Cleaning tool
11 Tool sled
12 Bracket
13 Pin
14 Hole
15 Railing
15a Gate
16 Rounded edge
17 Vacuum cleaner
18 Manual lifting device
19 Vehicle body
100 Framework structure
102 Upright members of framework structure
104 Storage grid
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1-22. (canceled)

23. A storage system comprising:
a framework structure having a plurality of storage columns for accommodating a vertical stack of storage containers;
a rail system upon which vehicles may move above the storage columns, wherein the rail system comprises first and second sets of rails arranged to guide movement of the vehicles in respective first and second directions; and
a service vehicle and at least one service sled,
wherein the service vehicle is configured to accommodate a human operator, comprises wheels for moving the service vehicle in the first and second directions, and comprises at least one sled connector configured to releasably attach the service vehicle to the service sled, and
wherein the service sled is configured to slide upon the rail system.

24. The storage system according to claim 23, wherein the service sled comprises a floor section having a bottom surface in sliding contact with rails of the rail system.

25. The storage system according to claim 24, wherein the bottom surface is flat.

26. The storage system according to claim 24, wherein the bottom surface has an area larger than a lateral area of two adjacent grid cells.

27. The storage system according to claim 24, wherein the bottom surface is made of a material having a lower hardness than the material of the rail system.

28. The storage system according to claim 24, wherein the bottom surface is made of a polymeric material.

29. The storage system according to claim 24, wherein the floor section comprises a rounded edge or an upwards inclined edge surface, at a periphery of the bottom surface.

30. The storage system according to claim 23, wherein the rail system is made of aluminium.

31. The storage system according to claim 23, wherein the service sled is any of: a platform for a human operator, a cleaning tool comprising a brush and/or a vacuum cleaner, or a tool sled featuring a manual lifting device for retrieval of a storage container.

32. The storage system according to claim 23, wherein the service sled comprises a railing.

33. The storage system according to claim 32, wherein a portion of the railing is moveable between opposite sides of the service sled.

34. The storage system according to claim 23, comprising two service sleds, the service sleds configured to be releasably attached at opposite sides of the service vehicle to provide a platform for the human operator.

35. The storage system according to claim 23, wherein the at least one sled connector is configured to restrict horizontal movement of the service sled relative to the service vehicle when the service vehicle is attached to the service sled.

36. The storage system according to claim 23, wherein the at least one sled connector is configured to allow vertical movement of the service vehicle relative to the service sled when the service vehicle is attached to the service sled.

37. The storage system according to claim 23, wherein the service sled comprises at least one bracket for releasable attachment to the sled connector.

38. The storage system according to claim 23, wherein the at least one sled connector is configured to releasably attach the service sled via a pin-hole connection.

39. The storage system according to claim 23, wherein the service vehicle comprises a first set of wheels and a second set of wheels, wherein at least one of the sets of wheels can be lifted and lowered, so that the first set of wheels and/or the second set of wheels can be selectively engaged with the rail system.

40. The storage system according to claim 23, comprising at least one container handling vehicle configured to move in two perpendicular directions above the storage columns, the container handling vehicle configured to retrieve, store, and/or transport storage containers.

41. A method of moving a service sled in a storage system according to claim 23, comprising the steps of:
releasably attaching the service vehicle to the service sled using the at least one sled connector; and
sliding the service sled upon the rail system by moving the service vehicle.

42. A service vehicle comprising:
at least one service sled;
wheels for moving the service vehicle in first and second directions on a rail system of a storage system; and
at least one sled connector configured to releasably attach the service vehicle to the service sled,
wherein the service sled is configured to slide upon the rail system.
